(19) United States
(12) Patent Application Publication
(10) Pub. No.: US 2012/0072115 A1
(43) Pub. Date: Mar. 22, 2012

(54) DETERMINATION OF NOTIONAL SIGNATURES

(75) Inventor: Robert Laws, Cambridge (GB)

(73) Assignee: WesternGeco LLC, Houston, TX (US)

(21) Appl. No.: 13/202,698

(22) PCT Filed: Feb. 15, 2010
(86) PCT No.: PCT/IB2010/000295

§ 371 Date: Nov. 26, 2011

(30) Foreign Application Priority Data
Mar. 18, 2009 (GB) 0904618.6

(51) Int. Cl. G01V 1/28; G06F 19/00

(52) U.S. Cl. 702/14

(57) ABSTRACT

A method of determining the signature of a seismic source array comprises determining a notional signature of at least one source of an array of n seismic sources from measurements of the emitted wavefield from the array made at 2n independent locations and from the relative positions of the sources of the array and the 2n independent locations. The notional signature of a source may be determined from the difference (or some other function) of the measurements of the emitted wavefield made by the two sensors associated with that source.

### BACKGROUND

The present invention relates to seismic surveying. In particular, it relates to determination of notional signatures of seismic sources in a seismic source array.

The general principle of seismic surveying is that one or more sources of seismic energy are caused to emit seismic energy such that it propagates downwardly through the earth. The downwardly-propagating seismic energy is reflected by one or more geological structures within the earth that act as partial reflectors of seismic energy. The reflected seismic, energy is detected by one or more sensors (generally referred to as “receivers”). It is possible to obtain information about the geological structure of the earth from seismic energy that undergoes reflection within the earth and is subsequently acquired at the receivers.

A typical seismic survey uses a source array containing two or more seismic sources. When a source array is actuated to emit seismic energy it emits, seismic energy over a defined period of time. The emitted seismic energy from a seismic source array is not at a single frequency but contains components over a range of frequencies. The amplitude of the emitted seismic energy is not constant over the emitted frequency range, but is frequency dependent. The seismic wavefield emitted by a seismic source array is known as the “signature” of the source array. When seismic data are processed, knowledge of the signature of the seismic source array used is desirable, since this allows more accurate identification of events in the seismic data that arise from geological structures within the earth. In simple mathematical terms, the seismic wavefield acquired at a receiver represent the effect of applying a model representing the earth's structure to the seismic wavefield emitted by the source array; the more accurate is the knowledge of the source array signature, the more accurately the earth model may be recovered from the acquired seismic data.

It has been suggested that one or more sensors may be positioned close to a seismic source, in order to record the source signature. By positioning the sensor(s) close to the seismic source the wavefield acquired by the sensor(s) should be a reliable measurement of the emitted source wavefield. WesternGeco's Trisor/CMS system provides estimates of the source wavefield from measurements with near-field hydrophones near each of the seismic sources composing the source arrays in marine seismic surveys.

FIG. 1(a) is a schematic perspective view of a marine seismic source array having 18 airgun positions A₁ . . . A₁₈ (for clarity, not all airgun positions are labelled). In use, an airgun or a cluster of two or more airguns is located at each airgun position—FIG. 1(a) shows, for illustration, a single airgun 1 at each of airgun locations A₂ to A₆, A₈ to A₁₂ and A₁₄ to A₁₈ and a cluster 2 of three airguns at positions A₁, A₇ and A₁₃. A near-field sensor is located near each airgun position to record the emitted wavefield—in this example a hydrophone H₁ . . . H₆ is located above each airgun positions A₁ . . . A₆ as shown in FIG. 1(b), which is a side view of one sub-array of the source array of FIG. 1(a).

FIG. 1(a) illustrates a further feature of seismic source arrays, which is that they are often comprised of two or more sub-arrays. The source array shown in FIG. 1(a) comprises three identical sub-arrays, with airgun positions A₁ to A₆ constituting one sub-array, airgun positions A₇ to A₁₂ constituting a second sub-array and airgun positions A₁₃- to A₁₈ constituting a third sub-array. The sources of a sub-array are suspended from a respective surface float F1, F2, F3. Each sub-array is towed from a seismic vessel using a high-pressure gun-cable (not shown), which supplies the sub-array with high-pressure air for the airguns. The gun-cable may also have optical fibres and power lines for the in-sea electronics in the source array.

The signature of a seismic source array is generally directional, even though the individual sources may behave as “point sources” that emit a wavefield that is spherically symmetrical. This is a consequence of the seismic source array generally having dimensions that are comparable to the wavelength of sound generated by the array.

The signature of a seismic source array further varies with distance from the array. This is described with reference to FIG. 2. An array of sources 3, in this example a marine source array positioned at a shallow depth below a water-surface 4, emits seismic energy denoted as arrows 5. In FIG. 2 a “near field” region 6 is shown bounded by a boundary 7 with a “far field” region 8 on the other side of the boundary. In the near field region 6 the shape of the near field signature from the array of seismic sources varies with distance from the array. At the notional boundary 7, however, the signature of the array may assume a stable form. In the far-field region 8, the far-field signature of the array maintains a constant shape, and the amplitude of the signature decreases at a rate that is inversely proportional to the distance from the source array: The notional boundary 7 separating the near field region 6 from the far-field region 8 is located at a distance from the source array approximately given by D²/λ, where D is the dimension of the array and λ is the wavelength.

In processing geophysical data, knowledge of the far-field signature of the source array is desirable, since most geological features of interest are located in the far-field region 8. Direct measurement of the far-field signature of the array is difficult, however, owing to the need to ensure that no reflected energy is received during measurement of the far-field signature.

The near-field signature of an individual seismic source may in principle be measured, for example in laboratory tests or in field experiments. However, knowledge of the source signatures of individual seismic sources is not sufficient to enable the far-field signature of a source array to be determined, since the sources of an array do not behave independently from one another.

Interactions between the individual sources of a seismic source array were considered in U.S. Pat. No. 4,476,553 (EP 0 066 423). The analysis specifically considered airguns, which are the most common seismic source used in marine surveying, although the principles apply to all marine seismic sources. An airgun has a chamber which, in use, is charged with air at a high pressure and is then opened. The escaping air generates a bubble which rapidly expands and then oscillates in size, with the oscillating bubble acting as a generator of a seismic wave. In the model of operation of a single airgun it is assumed that the hydrostatic pressure of the water surrounding the bubble is constant, and this is a reasonable assumption since the movement of the bubble towards the surface of the water is very slow. If a second airgun is discharged in the vicinity of a first airgun, however, it can no longer be assumed that the pressure surrounding the bubble generated by the first airgun is constant since the bubble generated by the first airgun will experience a seismic wave generated by the second airgun (and vice versa).

U.S. Pat. No. 4,476,553 proposed that, in the case of seismic source array containing two or more seismic sources, each seismic source could be represented by a notional near-field signature. In the example above of an array of two airguns, the pressure variations caused by the second airgun is absorbed, into the notional signature of the first airgun, and vice versa, and the two airguns may be represented as two independent airguns having their respective notional signatures. The far field signature of the array may then be found, at any desired point, from the notional signatures of the two airguns.

In general terms, U.S. Pat. No. 4,476,553, the contents of which are hereby incorporated by reference for all purposes, discloses a method for calculating the respective notional signatures for the individual seismic sources in an array of n sources, from measurements of the near-field wavefield made at n independent locations. When applied to the source array of FIG. 1, for example, measurements of the near field wavefield at each of the 18 hydrophone locations would allow the notional signatures for the 18 sources/clusters located at airgun positions A1 to A18 to be determined. The required inputs for the method of U.S. Pat. No. 4,476,553 are:
measurements of the near-field wavefield at n independent locations;
the sensitivities of the n near-field sensors used to obtain the n measurements of the near-field wavefield; and
the (relative) positions of the n sources and the n near-field sensors.

For the simple source array containing two seismic sources 9,10 shown in FIG. 3, notional signatures for the two sources may be calculated according to the method of U.S. Pat. No. 4,476,553 from measurements made by near-field sensors 11,12 at two independent location from the distances a₁₁, a₁₂ between the location of the first near-field measuring sensor 12 and the seismic sources 9, 10, from the distances a₂₁, a₂₂ between the location of the second near-field sensor 11 and the seismic sources 9, 10, and from the sensitivities of the two near-field sensors. (In some source arrays the near-field sensors are rigidly mounted with respect to their respective sources, so that the distances a₁₁ and a₂₂ are known.) Once the notional signatures have been calculated, they may be used to determine the signature of the source array at a third location 12, provided that the distances a₃₁, a₃₂ between the third location and the seismic sources 9, 10 are known.

Determination of a notional source according to the method of U.S. Pat. No. 4,476,553 ignores the effect of any component of the wavefield reflected from the sea bed and so is limited to application in deep water seismography. The method of U.S. Pat. No. 4,476,553 has been extended in GB Patent No. 2 433 594 to use “virtual sources” so as to take account of reflections at the sea-surface or at the sea bottom.

### BRIEF SUMMARY

The present invention provides a method of determining the signature of a seismic source array, the method comprising: determining a notional signature of at least one source of an array of n seismic sources from measurements of the emitted wavefield from the array made at 2n independent locations and from the relative positions of the sources of the array and the 2n independent locations. The notional signature of a source may be determined from the difference (or some other function) of the measurements of the emitted wavefield made by the two sensors associated with that source.

By measuring the emitted wavefield of sources of the array using two sensors (disposed at different positions from one another), rather than using one sensor as in the method of U.S. Pat. No. 4,476,553, the determination of the signature of the source becomes much less sensitive to errors in the positions of elements of the array.

The method may further comprise actuating the array of n seismic sources; and making measurements of the emitted wavefield at 2n independent locations.

The source array may comprises 2n sensors, a respective two of the sensors being associated with each source, and making measurements of the emitted wavefield at the 2n independent locations may comprise measuring an emitted pressure field using the 2n sensors.

The two sensors associated with a source may at different distances from the source to one another. They may be disposed in the near-field region of the source.

The method may comprise determining respective notional signatures for each of the n sources.

Respective notional signatures for each of the n sources may be determined according to the following n simultaneous equations or equations equivalent thereto:

S(i, t)=Lii*{[N₁(i,t−r₁ii/c)−S_{i≠j}S(j,t−r₁ij/c)/r₁ij]−[N₂(i,t−r₂ii/c)−S_{i≠j}S(j,t−r₂ij/c)r₂ij]}

or according to the following n simultaneous equations or equations equivalent thereto:

S(i, t)=Lii*{[N₁(i,t−rii/c)−N₂(i,t−rii/c)−S_{i≠j}S(j,t−rij/c)/Lij}

(References to determining the notional signatures according to specified equations is also intended to include determining the notional signatures by an approximate numerical solution of the specified equation.)

Other preferred features of the invention are set out in the other dependent claims.

Other aspects of the invention provide a complementary seismic source array, seismic surveying arrangement and computer-readable medium.

### BRIEF DESCRIPTION OF THE DRAWINGS

Preferred embodiments of the present invention will be described by way of illustrative example, with reference to the accompanying figures in which:

FIG. 1(a) is a schematic view of a marine seismic source array having three sub-arrays;

FIG. 1(b) is a side view of one sub-array of the marine seismic source array of FIG. 1(a);

FIG. 2 illustrates propagation of a signature from an array of seismic sources;

FIG. 3 illustrates determination of a notional signature for an array of seismic sources;

FIG. 4 shows the ratio rij/Lij for a typical marine seismic source array;

FIG. 5 shows an estimate of the far-field signature obtained by a prior method;

FIG. 6 shows an estimate of the far-field signature obtained by a method of the invention;

FIG. 7 shows the effect of positional errors on an estimate of the far-field signature obtained by a prior method;

FIG. 8 shows the effect of positional errors on an estimate of the far-field signature obtained by a method of the invention;

FIG. 9 is a block schematic flow diagram showing principal steps of a method according to an embodiment of the present invention;

FIG. 10 is a schematic diagram of a seismic source array according to an embodiment of the present invention; and

FIG. 11 is a schematic block diagram of an apparatus of the present invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment or computer-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The method of U.S. Pat. No. 4,476, 553 determines the notional signatures of the sources of an array by solving the equation:

S(i, t)=rii*[N(i,t−rii/c)−S_{i≠j}S(j,t−rij/c)/rij] (1)

where S(i, t) is the ‘notional source signature’ of source i at time t, N(i, t) is the near field measurement of the sensor (hydrophone) near source i at time t, rij is the distance from hydrophone i to source j, and c is the velocity of sound in the medium surrounding the source array. (Strictly, equation (1) defines a set of n simultaneous equations, one for each source.)

The equation is solved recursively in time; the terms in S on the right are only needed at earlier times than the time currently being computed.

The subtracted summed terms on the right in equation (1) are known as the ‘interaction terms’. Equation (1) takes the measurement from the hydrophone nearest to a gun, subtracts from it the pressure that it has received from all the other guns so that the hydrophone effectively only listens to the gun nearest to it. The difficulty with this approach is that the interaction terms that are subtracted are of a similar size to the measurement term N, so the result is prone to error as minor errors in the interaction terms or the measurement N can lead to large errors in the determined notional source signature.

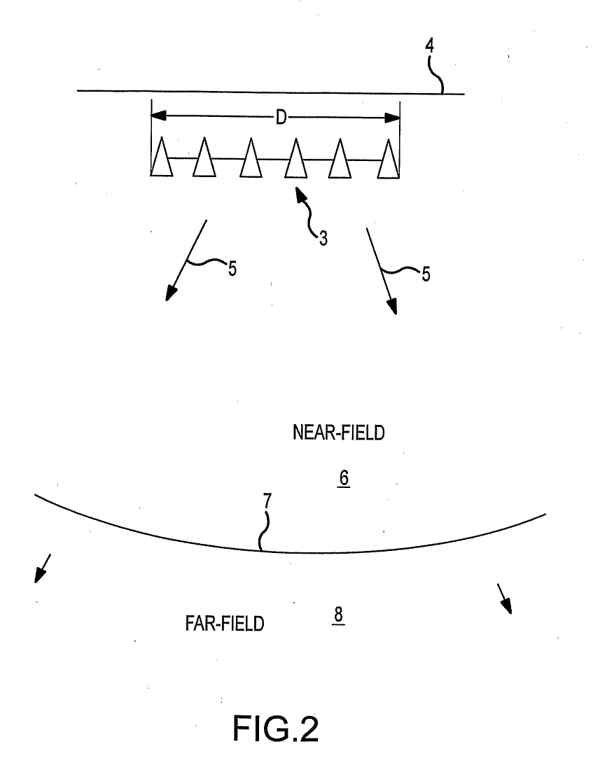

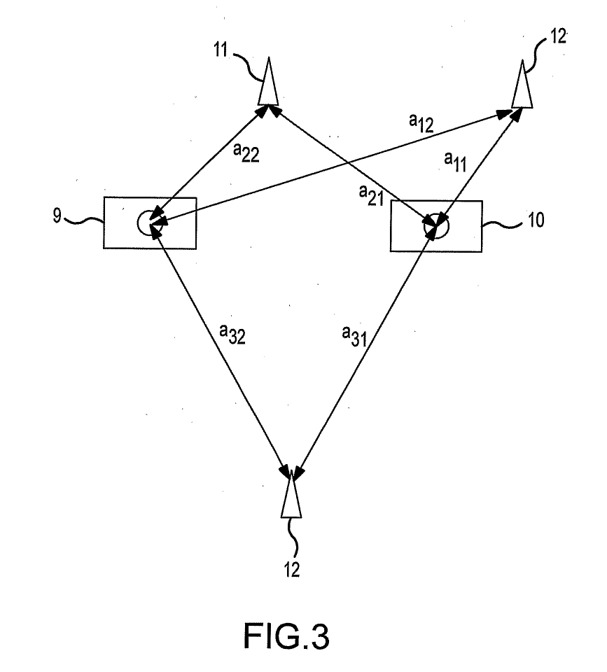

In the present invention, two hydrophones (or other sensors) are provided for each source of the array, so that a source array of n sources will contain 2n sensors for measuring the emitted pressure field, two sensors associated with each of the sources. The two sensors associated with a source of the array are placed at two different distances from the source but are both close to the source (and are generally in the “near field” region shown in FIG. 2). By using the difference between the measurements made by the two hydrophones associated with a source (or perhaps using another function based on the measurements made by the two hydrophones), a ‘dual hydrophone’ equation giving the notional signature S(i,t) of the ith source in terms of the measurements made by the two hydrophones can be derived according to the following equation, or equivalent equations thereto:

S(i, t)=Lii*{ [N₁(i,t−r₁ii/c)−S_{i≠j}S(j,t−r₁ij/c)]−[N₂(i,t−r₂ii/c)−S_{i≠j}S(j,t−r₂ij/c)/r₂ij]} (2)

where

Lii=1/(1/r₁ii−1/r₂ii) (3)

In equation (2), N1(i,t) and N2(i,t) are the measurements made by the two hydrophones associated with the ith source, and r₁ij [r₂ij] is the distance from hydrophone number 1 [number 2] at gun position i to the bubble at gun position j. Other terms have the same meaning as in equation (1).

Equation (2) may be simplified by making the approximation

(i₁ii−r₂ii)/c<<1/fmax (for all i). (4)

where fmax is the maximum frequency emitted by the, sources of the array. That is to say, it is assumed that the separation of the hydrophone pair is small compared with the shortest wavelength of interest. This is a very good approximation for a typical seismic survey.

With the approximation of equation (4), equation (2) may be re-written as:

S(i, t)=Lii*{[N₁(i,t−rii/c)−N₂(i,t−rii/c)−S_{i≠j}S(j,t−rij/c)/Lij} (5)

equation (5) is very similar to equation (1), except that it uses the difference between the two near field measurements in place of the single measurement of (1) and also that it uses L instead of r.

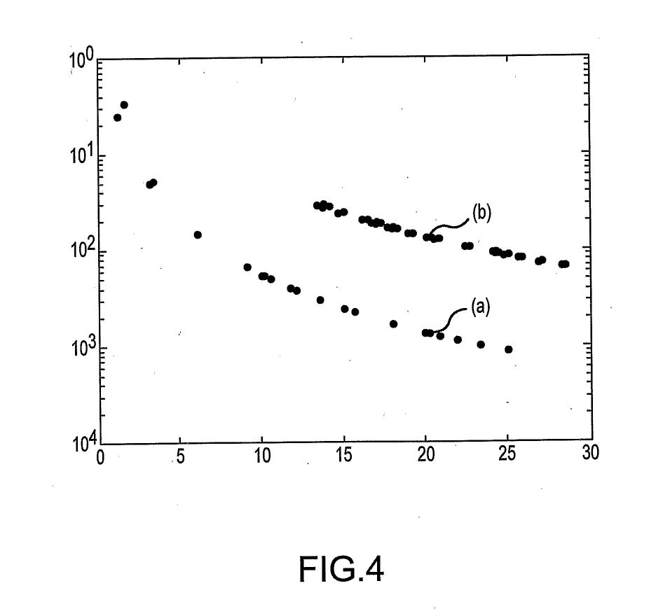

If the two near field hydrophones are placed close to the source but not at equal distances from the source (for example at 1.2 and 1.4 meters from the source) then (N₁-N₂) in equation (5) is of the same order as N in equation (1). However, the term Lij appearing in equation (5) is much larger than rij (for i≠j). This is illustrated in FIG. 4, which shows the ratio rij/Lij for gun to hydrophone distances in a typical marine seismic array. For each airgun of the source, the two near-field hydrophones for that source are at 1.2 m and 1.6 m from the airgun. It can be seen that the ratio rij/Lij is significantly less than 1 (ie, that Lij is greater than rij) except for the two points in the top left of FIG. 4. These are the “direct terms” that represent the direct signal from each gun to its own pair of hydrophones, ie the case i=j.

It can be seen that the remaining points in FIG. 4 lie on two curves. One curve, labelled “a”, corresponds to interactions, ie relates to distances between a source of the array and hydrophones associated with a different source of the array. The other curve, labelled “b”, corresponds to ghost signals, ie relates to distances between a source of the array and hydrophones associated with a different source of the array via reflection at the sea surface.

The fact that Lij is greater than rij (except for the direct terms) means that the interaction terms in equation (5) are much less significant than they are in equation (1), and the method of the invention is therefore less sensitive to errors in the interaction terms. (The direct signal does not appear in the interaction terms of (5).) In particular, the method, of the invention is less sensitive to errors in the positions of the near-field hydrophones relative to the sources.

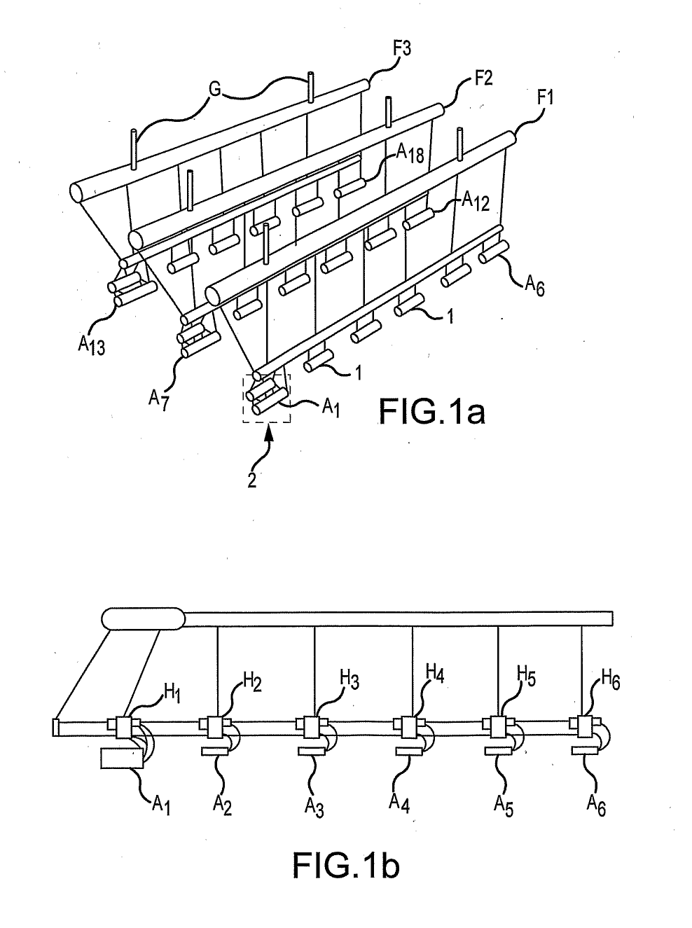

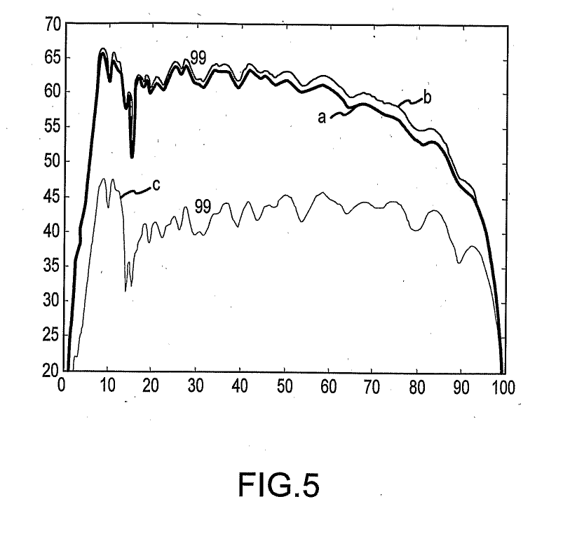

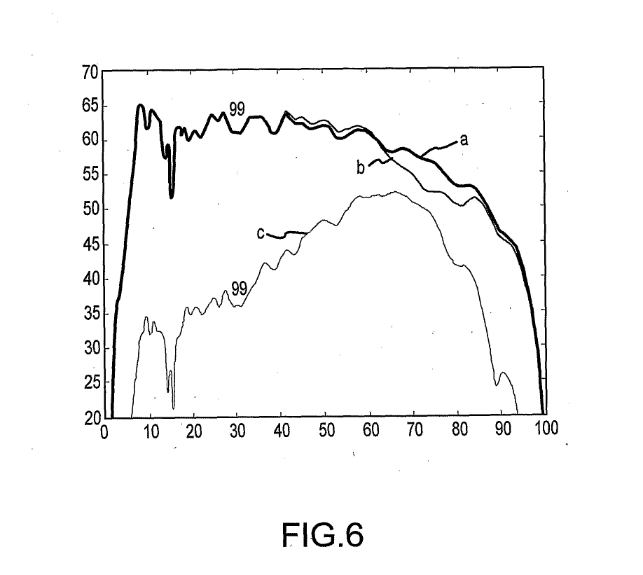

FIGS. 5 and 6 show how the method of U.S. Pat. No. 4,476,553 and the method of the present invention perform in the absence of positional errors, that is, when the positions of the near-field sensors and the sources are known exactly. FIG. 5 shows the true far-field signature for a source array as trace “a”, the signature as estimated by the method of U.S. Pat. No. 4,476,553 as trace “b”, and the error as trace “c”, and FIG. 6 is similar except that trace “b” shows the signature as estimated by the method of U.S. Pat. No. 4,476,553. FIGS. 5 and 6 relate to a source array having 18 airguns, positioned at a depth of 7.5 metres below the sea surface, and show the signature as a function of the frequency (this was estimated for a source array with 3 sub arrays of 6 sources each, as in FIG. 1). As can be seen, both methods perform adequately when there are not positional errors and trace “b” in each of the figures is a good match to the true signature of trace “a”.

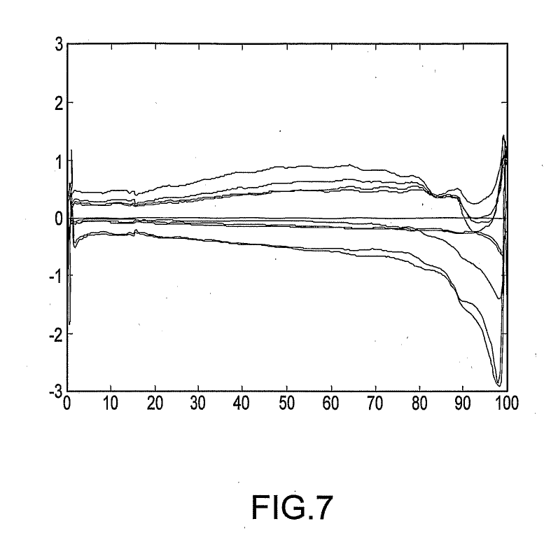

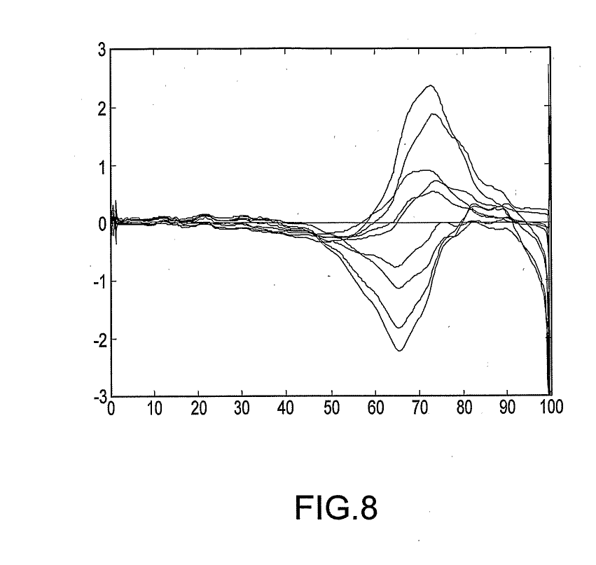

FIGS. 7 and 8 illustrate the sensitivity of the two methods to positional errors. FIG. 7 illustrates variation in the far field signature estimated by the method of U.S. Pat. No. 4,476,553 as a result of horizontal positional errors in the source subarrays. Each trace in FIG. 7 shows the error between (1) the far field signature as calculated for a set of positions of the sensors and sources that is different from the intended position, and (2) the far field signature as estimated according to the method of U.S. Pat. No. 4,476,553 on the assumption that every source and every hydrophone is at its intended position (the line of zero error is also plotted in FIG. 7, as a guide). The standard deviation of position is 1 m meter inline and 1 m crossline. FIG. 8 corresponds to FIG. 7, but shows the error between (1) the far field signature as calculated for a set of positions of the sensors and sources that is different from the intended position, and (2) the far field signature as estimated according to a method of the present invention on the assumption that every source and every hydrophone is at its intended position. Comparison of FIGS. 7 and 8 shows that, at frequencies below 50 Hz, the method of the invention is much less sensitive to positional errors than is the prior method.

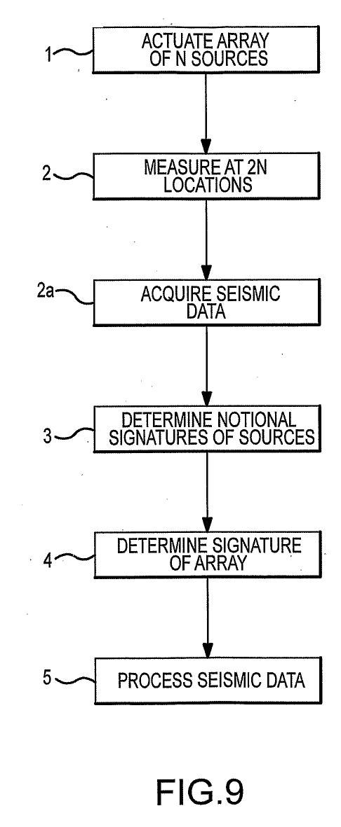

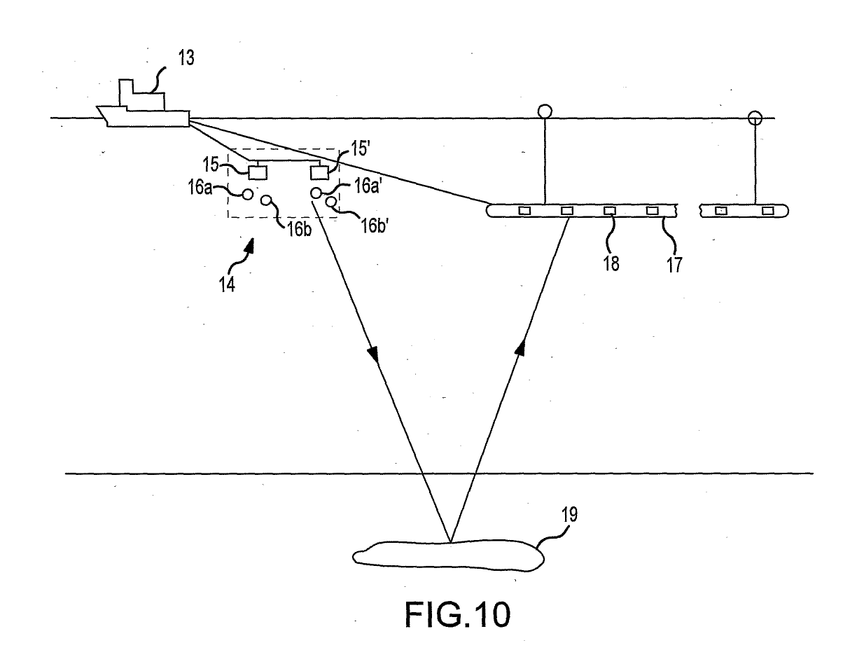

FIG. 9 is a block flow diagram of a method according to an embodiment of the invention. A suitable seismic source array for use in this method is described in FIG. 10.

Initially at step 1, an array of n seismic sources is actuated to emit seismic energy. It will be assumed in the foregoing description that all n sources of the array are actuated to emit seismic energy, but the invention is not limited to this and it is not intended to exclude application of the invention to know methods in which only selected sources of a source array are actuated for example to provide a desired centre of shot.

At step 2, the emitted wavefield from the source array is measured at 2n independent locations, whose positions (or intended positions at least) relative to the positions of the sources of the array are known. Preferably, two of the 2n locations are near to each of the sources of the array.

Optionally, seismic data may also be acquired at step 2a, consequent to actuation of the source array, at one or more seismic receivers.

At step 3, a notional signature is estimated for at least one of the sources of the source array, and preferably a notional signature is estimated for each source of the source array. (If only selected sources of the source array were actuated at step 1, it is possible to estimate notional signatures only for those sources that were actuated.) The notional signature(s) are estimated from the 2n measurements of the emitted wavefield made at step 2, and from knowledge of the locations at which the measurements were made relative to the locations of the sources.

Preferably, at step 3 a notional signature is estimated for each source of the source array using equation (2) or equation (5).

The signature of the source array may then be estimated at step 4, by superposing the notional signatures estimated at step 3 for each source of the array.

The source signature estimated at step 4 may then be used in processing seismic data acquired using the source array, in particular in processing any seismic data acquired at step 2a. This is shown schematically as step 5, which consists of processing the seismic data to obtain information about at least one parameter of the earth's interior. As explained above, the more accurate is the knowledge of the signature of the source array signature allow, the more accurately information about the earth's interior may be recovered from the acquired seismic data, and therefore the source signature estimated at step 4 is preferably taken into account during the processing of step 5.

Step 5 may consist of applying one or more processing steps to the seismic data. The nature of the processing of step 5 is not related to the principal concept of the invention, and will therefore not be described further.

FIG. 10 is a side view of a seismic surveying arrangement that includes a seismic source array according to an embodiment of the present invention. FIG. 10 shows a marine seismic source array, but the invention is not in principle limited to marine seismic source arrays.

FIG. 10 illustrates a seismic surveying arrangement known as a towed marine seismic survey. A seismic source array 14, containing n seismic sources 15,15′, is towed by a survey vessel 13. Only two sources are shown in the source array of FIG. 10 but the source array may have more than two sources. In the case of a marine seismic source array the sources may be airguns, but the invention is not limited to airguns as the sources.

The source array further comprises near-field sensors, for example near-field hydrophones (NFH), provided for measuring the near-field signatures of the sources of the array. According to the present invention, a respective pair of sensors are associated with each source, for example are provided in the nearfield region of each source of the array 14, so that two near field sensors 16a, 16b are provided in the nearfield region of source 15, two near field sensors 16a′, 16b′ are provided in the nearfield region of source 15′, and so on giving a total of 2n near-field sensors. The near-field sensors 16a, 16b associated with a source are disposed close to the source so as to be in the near field region 6 of FIG. 2. In the case of an airgun source, however, the near-field sensors should not be placed so close to the airgun that they are likely to be enveloped by the bubble emitted by the airgun, and this typically requires that the near-field sensors are no closer than 1 m to the airgun. In typical source arrays, the near-field sensors may be between 1 m and 2 m away from the associated source.

The two near-field sensors 16a, 16b associated with a source are preferably disposed at different distances from the source, merely by way of example one near-field sensor may be 1.2 meters from the source and the other may be 1.6 meters from the source, as in the simulations described above.

The near-field sensors may be mounted on the source array in any suitable manner, for example in a similar manner to the hydrophones in the source array of FIG. 1(b). Details of the mounting are omitted from FIG. 10 for clarity. Preferably the near-field sensors are mounted on the source array so that the position of the near-field sensor is fixed or substantially fixed relative to the position of the associated source.

The seismic surveying arrangement of FIG. 10 further includes one or more receiver cables 17, with a plurality of seismic receivers 18 mounted on or in each receiver cable 17. FIG. 10 shows the receiver cable(s) as towed by the same survey vessel 13 as the source array 14 via a suitable front-end arrangement 20, but in principle a second survey vessel could be used to tow the receiver cable(s) 17. The receiver cables are intended to be towed through the water a few metres below the water-surface, and are often known as “seismic streamers”. A streamer may have a length of up to 5 km or greater, with receivers 18 being disposed every few metres along a streamer. A typical lateral separation (or “cross-line” separation) between neighbouring streamers in a typical towed marine seismic survey is of the order of 100 m.

One or more position determining systems (not shown) may also be provided on the source array to provide information about the position of the source array.

When one or more sources of the source array are actuated, they emit seismic energy into the water, and this propagates downwards into the earth's interior until it undergoes (partial) reflection by some geological feature 19 within the earth. The reflected seismic energy is detected by one or more of the receivers 18. As described above with reference to step 4 of FIG. 9, the seismic data acquired by the receivers 18 may be processed to obtain information about the geological structure of the earth's interior, for example to allow location and/or characterisation of oil or gas reservoirs.

A detailed description of the streamer(s) 17 is not relevant to the present invention, and will not be given here. When a source array of the present invention is used in a towed marine seismic survey, any commercially available streamers may be used with the source array.

The invention has been described with reference to a marine source array used in a towed marine seismic survey. The invention is not however limited to this, and may in principle be applied to any seismic source array. Furthermore, although the invention has been described with reference to a source array having airguns as the sources and hydrophones as the near-field sensors, the invention is also not limited to this arrangement/structure.

The invention has also been described with reference to a “peak tuned” source array in which it is intended that all sources of the array are actuated at the same time in step 1 of FIG. 9. The invention is not limited to this however, and may be applied to source arrays in which the sources are fired with a short delay (for example to obtain “beamsteering”), provided that the resultant shot pattern still results in overlapping signals at the near-field sensor positions.

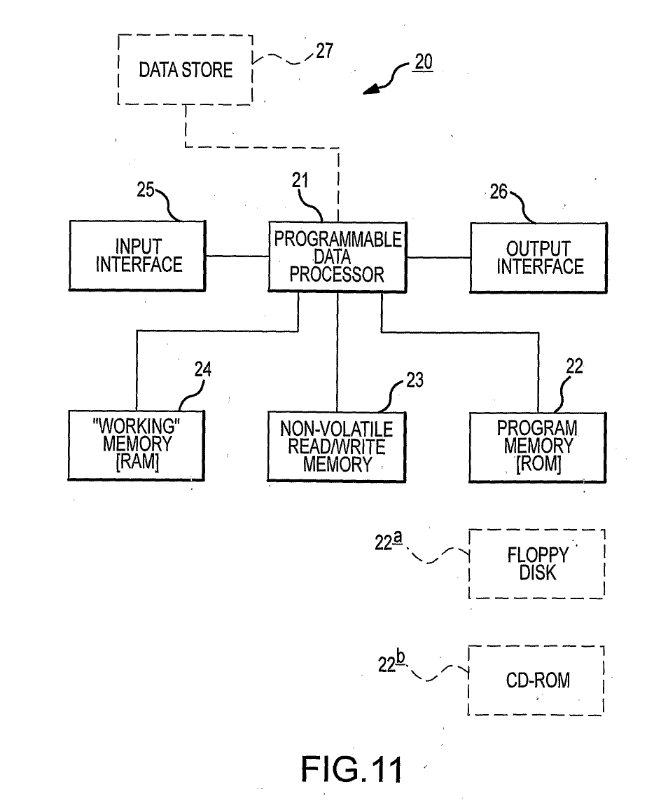

FIG. 11 is a schematic block diagram of a programmable apparatus 20 according to the present invention. The apparatus comprises a programmable data processor 21 with a program memory 22, for instance in the form of a read-only memory (ROM), storing a program for controlling the data processor 21 to perform any of the processing methods described above. The apparatus further comprises non-volatile read/write memory 23 for storing, for example, any data which must be retained in the absence of power supply. A “working” or scratch pad memory for the data processor is provided by a random access memory (RAM) 24. An input interface 25 is provided, for instance for receiving commands and data. An output interface 26 is provided, for instance for outputting or displaying information relating to the progress and result of the method. Data from the near-field sensors for processing may be supplied via the input interface 25, or may alternatively be retrieved from a machine-readable data store 27.

The apparatus may further be adapted to process acquired seismic data, using the determined notional signatures. In such a case, data from receivers for processing may be supplied via the input interface 25, or may alternatively be retrieved from the machine-readable data store 27.

The program for operating the system and for performing a method as described hereinbefore is stored in the program memory 22, which may be embodied as a semi-conductor memory, for instance of the well-known ROM type. However, the program may be stored in any other suitable storage medium, such as magnetic data carrier 22a, such as a “floppy disk” or CD-ROM 22b.

The apparatus 20 may for example, be provided on the survey vessel 13 towing the source array so that at least some processing of the data from the near-field sensors and/or of seismic data acquired by the receivers on the receiver cables 17 may be performed on the survey vessel. Alternatively, the apparatus 20 may be in a remote processing centre, to which data from the near-field sensors and/or seismic data acquired by the receivers on the receiver cables 17 are transmitted.

1. A method of determining the signature of a source array, the method comprising:
determining a notional signature of at least one source of an array of n sources from measurements of the emitted wavefield from the array made at 2 n independent locations and from the relative positions of the sources of the array and the 2 n independent locations; and
processing seismic data acquired consequent to actuation of the source array to obtain information about one or more parameter of the earth's interior; wherein processing the acquired seismic data comprises taking the determined notional signature of at least one source of the array into account.

2. A method as claimed in claim 1, wherein the step of determining a notional signature of at least one source of the array of n sources from measurements of the emitted wavefield from the array made at 2 n independent locations comprises:
actuating the array of n seismic sources; and
making measurements of the emitted wavefield at 2 n independent locations.

3. A method as claimed in claim 1 wherein the source array comprises 2 n sensors, a respective two of the sensors being associated with each source, and wherein making measurements of the emitted wavefield at the 2 n independent locations comprises measuring an emitted pressure field using the 2 n sensors.

4. A method as claimed in claim 3 wherein the two sensors associated with a source are at different distances from the source to one another.

5. A method as claimed in claim 3 wherein the two sensors associated with a source are disposed in the near-field region of the source.

6. A method as claimed in claim 3 wherein determining a notional signature of at least one source of the array comprises determining respective notional signatures for each of the n sources.

7. A method as claimed in claim 6 and comprising determining the signature of the source array by superposing the notional signatures of each of the n sources.

8. A method as claimed in claim 6 wherein determining respective notional signatures for each of the n sources comprises determining the notional signatures according to the following n simultaneous equations or equations equivalent thereto:
S(i, t)=Lii*{ [N₁(i,t−r₁ii/c)−S_{i≠j}S(j,t−r₁ij/c)/r₁ij]−[N₂(i,t−r₂ii/c)−S_{i≠j}S(j,t−r₂ij/c)/r₂ij] }
where S(i, t) is the notional signature of the ith source of the array (1<i<n), N₁(i,t) and N₂(i,t) are the measurements made by the two sensors associated with the ith source of the array, rij is the distance from the ith sensor to the jth of the sources, c is the velocity of sound, and Lii=1/(1/r₁ii−1/r₂ii).

9. A method as claimed in claim 6 wherein determining respective notional signatures for each of the n sources comprising determining the notional signatures according to the following n simultaneous equations or equations equivalent thereto:
S(i, t)=Lii*{ [N₁(i,t−rii/c)−N₂(i,t−rii/c)−S_{i≠j}S(j,t−rij/c)/Lij}
where S(i, t) is the notional signature of the ith source of the array (1<i<n), N₁(i,t) and N₂(i,t) are the measurements made by the two sensors associated with the ith source of the array, rij is the distance from the ith sensor to the jth of the sources, c is the velocity of sound, and Lii=1/(1/r₁ii−1/r₂ii).

10. A method as claimed in claim 1 wherein the seismic source array is a marine seismic source array.

11. A method as claimed in claim 10 wherein the seismic sources are airguns.

12. A method as claimed in claim 9 wherein the sensors are hydrophones.

13. A method as claimed in claim 2 and further comprising acquiring seismic data at one or more seismic receivers consequent to actuating the seismic source array.

14. A method as claimed in claim 7, wherein processing the acquired seismic data comprises taking the determined notional signature of the source array into account.

15. A seismic source array comprising: n seismic sources, each seismic source having associated respective first and second sensors for measuring an emitted wavefield.

16. A seismic source array as claimed in claim 15 wherein the first and second sensors associated with a seismic source are disposed at different distances from the source.

17. A seismic source array as claimed in claim 15 wherein the first and second sensors associated with a seismic source are disposed in the near-field region of the source.

18. A seismic source array as claimed in claim 15, wherein the seismic source array is a marine seismic source array.

19. A seismic source array as claimed in claim 18 wherein the seismic sources are airguns.

20. A seismic source array as claimed in claim 18 wherein the sensors are hydrophones.

21. A seismic surveying arrangement comprising: a seismic source array as defined in claims 15; and means for determining a notional signature of at least one source of an array of n sources from measurements of the emitted wavefield from the array made at 2 n independent locations and from the relative positions of the sources of the array and the 2 n independent locations.

22. A seismic surveying arrangement comprising: a seismic source array as defined in claims 15; and one or more seismic receivers.

23. A computer-readable medium containing instructions that, when executed on a processor, perform a method as defined in claim 1.
